(19) United States
(12) Patent Application Publication
(10) Pub. No.: US 2023/0013119 A1
(43) Pub. Date: Jan. 19, 2023

(54) TAINTED ASSET MARKER MANAGEMENT

(71) Applicant: International Business Machines Corporation, Armonk, NY (US)

(72) Inventors: Nitin Gaur, Round Rock, TX (US); Petr Novotny, Mount Kisco, NY (US); Timothy Olson, Port Orchard, WA (US); Qi Zhang, West Harrison, NY (US); Lei Yu, SLEEPY HOLLOW, NY (US)

(21) Appl. No.: 17/379,639

(22) Filed: Jul. 19, 2021

(51) Int. Cl. G06Q 20/40; G06Q 30/00; G06Q 20/06

(52) U.S. Cl. CPC G06Q 20/4016; G06Q 30/018; G06Q 20/0658; G06Q 2220/123

(57) ABSTRACT

Systems, methods, and computer programming products for detecting, clearing and/or separating potentially tainted digital assets entering a digital network, providing an avenue to satisfy regulatory requirements and ensure digital asset trading is uninterrupted due to the presence of tainted assets. Specialized nodes of the blockchain network intercept incoming transactions and routes the digital assets to a clearing house for analysis, processing and separation of potentially tainted assets. The clearing house uses a plurality of techniques to track, trace and analyze digital assets using techniques provided by the blockchain network or utilizing one or more service providers. Cleared assets are processed and channeled from the clearing house to the wallets or addresses designated by the transaction information and assets with high potential for being tainted are placed within a special wallet for additional clearance and regulatory scrutiny.

### TECHNICAL FIELD

The present disclosure relates generally to the fields of blockchain and cryptocurrency security and more specifically to detecting and clearing tainted or potentially tainted digital assets involved in cryptocurrency exchanges.

### BACKGROUND

A cryptocurrency exchange is a digital marketplace where traders can buy, sell and exchange digital assets. The exchange is a platform that acts as an intermediary between buyers and sellers of the cryptocurrency or other digital assets and can operate similar to a brokerage, wherein money and/or digital assets can be deposited and transferred. There are two broad categories of exchanges for trading digital assets. There are centralized exchanges (CEX) and decentralized exchanges (DEX). CEX's function as a trusted intermediary during trades between two participants. The CEX acts as a custodian by storing and protecting funds and may further facilitate other aspects of the trade, including security, pricing, regulatory compliance, consumer protections and access to the various digital assets. In contrast, DEX's are a type of cryptocurrency exchange which allows for direct peer-to-peer cryptocurrency transactions, without the use of intermediaries and/or a centralized point of authority controlling the exchange of the digital assets. DEX's typically do not act as custodians of the digital assets being traded, therefore the private parties to the exchange maintain and control their own private keys to their wallets.

Digital assets that have been used in criminal transactions are considered “tainted” and may be forever linked with the nefarious activity. While blockchain forensics software can map how far removed an exchange of digital assets may be from the suspected criminal activity (such as an exchange hack), proving that the digital assets are still in the control of the offending party instead of having been sold to an innocent third party, is virtually impossible. Most regulated blockchain networks, including the ones that are operating over public network are required to provide a key regulatory feature called freezing and forfeiture. Freezing and forfeiture applies in situations where tainted cryptocurrency is identified as being part of a nefarious or fraudulent transaction. The network cannot continue to allow the tainted (or potentially tainted) currency to be freely exchanged because such free exchange would result in reputational risk of the network. Accordingly, as a result, networks freeze a participants entire account or wallet due to a presence or a transaction of a tainted asset. This can result in economic loss and loss in normal business activity.

### SUMMARY

Embodiments of the present disclosure relate to a computer-implemented method, an associated computer system and computer program products for detecting, clearing and separating potentially tainted digital assets entering a digital network. The computer-implemented method comprises the steps of routing, by a processor, the potentially tainted digital assets entering the blockchain network as part of a blockchain transaction, to a clearing house; querying, by the processor, an index maintained by the clearing house, said index mapping identifying information of the potentially tainted digital assets to elements of a directional graph; traversing, by the processor, the directional graph to isolate a sub-graph depicting movement of the potentially tainted digital assets between accounts or wallet addresses; separating, by the processor, the potentially tainted digital assets involved in the transaction from non-tainted assets isolated within the sub-graph; calculating, by the processor, a maximum amount of the potentially tainted digital assets moved between the accounts or the wallet addresses; and placing, by the processor, a hold on the maximum amount of the potentially tainted digital assets.

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1 depicts a block diagram illustrating internal and external components of an embodiment of a computing system in which embodiments described herein may be implemented in accordance with the present disclosure.

FIG. 2 depicts a functional block diagram describing an embodiment of a computing environment for detecting, clearing and separating potentially tainted digital assets entering a digital network in accordance with the present disclosure.

FIG. 3A depicts a block diagram comprising a workflow describing an embodiment of a directional graph identifying and tracking the relative states of digital assets in a history of transactions for each node in accordance with the present disclosure.

FIG. 3B depicts a block diagram comprising an embodiment of a workflow describing a traversal of directional graph within an isolated scope, identifying and tracking the movement of tainted assets during clearance processing, in accordance with the present disclosure.

FIG. 4 depicts a block diagram comprising an embodiment of a workflow describing clearance of digital assets during a decentralized digital asset exchange on a blockchain network in accordance with the present disclosure.

FIG. 5 depicts an embodiment of a blockchain architecture configuration in accordance with the present disclosure.

FIG. 6 depicts a flow diagram describing an embodiment of a method for detecting, clearing and separating potentially tainted digital assets entering a digital network in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

Overview

Embodiments of the present disclosure recognize that currently existing digital asset exchanges using blockchain technology lack technological capabilities to discern whether incoming digital assets entering the digital network obtained through nefarious means such as hacking, are currently within the hacker's control or have already been passed off at a certain point in time to an unsuspecting third party. At the present time, when blockchain networks suspect that digital assets being exchanged over the network are tainted or obtained through nefarious means, the assets of the user's entire account or wallet can be frozen or forfeited. In situations where the account or wallet belong to an unsuspecting third party that unknowingly received the tainted digital assets, such an account or wallet freeze or forfeiture could be considered unfair, and undue punishment resulting in economic loss. Accordingly, there is a need for limiting the proliferation of tainted assets across a network before the tainted assets spread to a plurality of unknowing third parties, as well as a need for being able to securely isolated and remove tainted assets, without impacting the entire accounts or wallets on the network containing untainted assets.

Embodiments of the present disclosure provide for a continuous processing framework using a clearing house to clear and scrutinize all incoming digital assets being traded on the blockchain network. When a device accesses the blockchain network to make a digital asset exchange or transaction, a specialized node acting as a gateway to the blockchain network interacts with the user's client (e.g., such as a web browser) to receive the incoming transaction and intercept the transaction, routing the assets incoming to the blockchain network to a clearing house instead of directly to a recipient's wallet or account. Embodiments of the clearing house track, trace and analyze past transactions and addresses of the incoming assets using services of the blockchain network and/or other service providers for signs of being part of past nefarious transactions, such as a hack or theft. Assets identified as having been tainted or a high potential for being tainted can be placed onto a hold and moved into a special wallet accessible by the clearing house for additional regulatory scrutiny. The remaining assets of the transaction that have been cleared by the clearing house can proceed to the wallet or account addresses prescribed by the transaction.

Embodiments of the clearing house track and trace historical transactions by dynamically maintaining a directional graph tracing history of the assets' transactions. Edges and nodes of the directional graph can be indexed to provide for efficient querying of the asset and quick responses for scrutinizing the assets during clearance, preventing tainted assets from further expanding the tainted asset's impact on the blockchain network. The index can be built by mapping each of the properties used as identifier information of the tainted assets to elements of the graph. For example, by mapping nodes to accounts or wallet addresses and transaction IDs to edges of the graph. The directional graph can be traversed starting from the problematic accounts identified as the source the potentially tainted assets and tracked along the edges to identify the movements of the tainted digital assets and any victims or other participants related to the tainted assets. During graph traversal, a scope for resolving tainted assets is established and isolated to form a sub-graph, wherein the maximum number of potentially tainted assets exchanged between accounts or wallets can be calculated and held for further scrutiny, while allowing the transactions to proceed for remaining accounts or wallet assets coming in contact with the tainted assets to be cleared and proceed.

Computing System

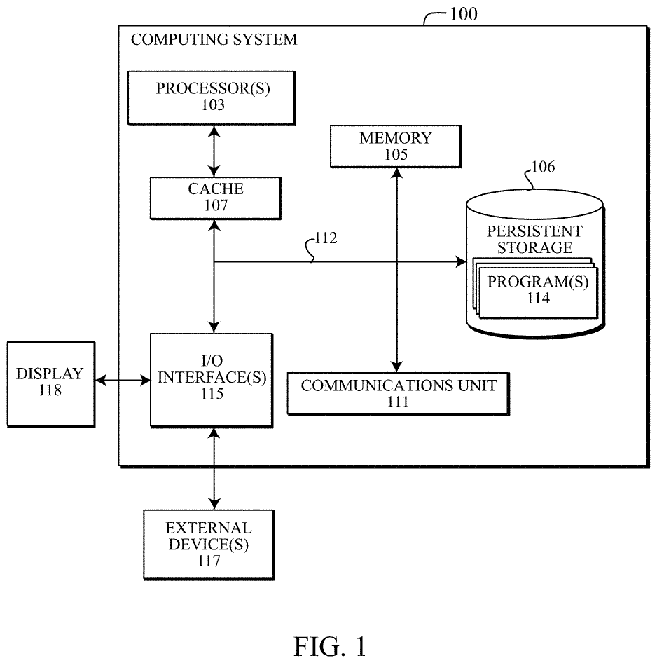

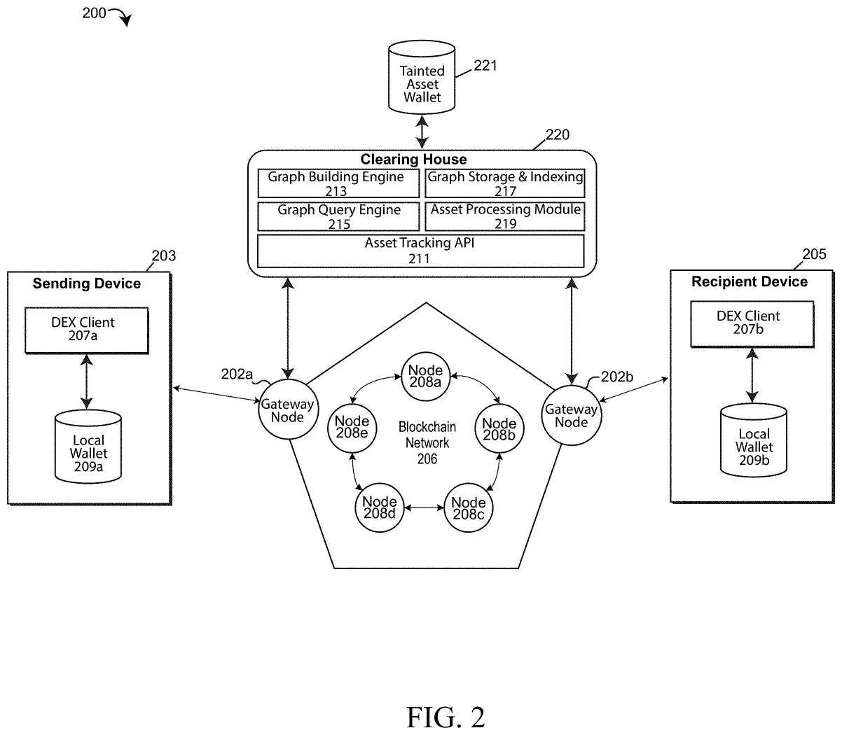

FIG. 1 illustrates a block diagram of an embodiment of a computing system 100, which may be a simplified example of a computing device (i.e., a physical bare metal system or virtual system) capable of performing the computing operations described herein for detecting and clearing tainted or potentially tainted digital assets entering a blockchain network. Computing system 100 may be representative of the one or more computing systems or devices implemented as part of computing environments depicted in FIGS. 2-5, in accordance with the embodiments of the present disclosure and further described below in detail. It should be appreciated that FIG. 1 provides only an illustration of one implementation of a computing system 100 and does not imply any limitations regarding the environments in which different embodiments may be implemented. In general, the components illustrated in FIG. 1 may be representative of any electronic device, either physical or virtualized, capable of executing machine-readable program instructions.

Although FIG. 1 shows one example of a computing system 100, a computing system 100 may take many different forms, including bare metal computer systems, virtualized computer systems, container-oriented architecture, microservice-oriented architecture, etc. For example, computing system 100 can take the form of real or virtualized systems, including but not limited to desktop computer systems, laptops, notebooks, tablets, servers, client devices, network devices, network terminals, thin clients, thick clients, kiosks, mobile communication devices (e.g., smartphones), multiprocessor systems, microprocessor-based systems, minicomputer systems, mainframe computer systems, smart devices, sensor device, recording devices, and/or Internet of Things (IoT) devices. The computing systems 100 can operate in a local computing environment, networked computing environment, a containerized computing environment comprising one or more pods or clusters of containers, and/or a distributed cloud computing environment, which can include any of the systems or devices described herein and/or additional computing devices or systems known or used by a person of ordinary skill in the art.

Computing system 100 may include communications fabric 112, which can provide for electronic communications among one or more processor(s) 103, memory 105, persistent storage 106, cache 107, communications unit 111, and one or more input/output (I/O) interface(s) 115. Communications fabric 112 can be implemented with any architecture designed for passing data and/or controlling information between processor(s) 103 (such as microprocessors, CPUs, and network processors, etc.), memory 105, external devices 117, and any other hardware components within a computing system 100. For example, communications fabric 112 can be implemented as one or more buses, such as an address bus or data bus.

Memory 105 and persistent storage 106 may be computer-readable storage media. Embodiments of memory 105 may include random access memory (RAM) and/or cache 107 memory. In general, memory 105 can include any suitable volatile or non-volatile computer-readable storage media and may comprise firmware or other software programmed into the memory 105. Program(s) 114, software applications, processes, services, and installed components thereof, described herein, may be stored in memory 105 and/or persistent storage 106 for execution and/or access by one or more of the respective processor(s) 103 of the computing system 100.

Persistent storage 106 may include a plurality of magnetic hard disk drives, solid-state hard drives, semiconductor storage devices, read-only memories (ROM), erasable programmable read-only memories (EPROM), flash memories, or any other computer-readable storage media that is capable of storing program instructions or digital information. Embodiments of the media used by persistent storage 106 can also be removable. For example, a removable hard drive can be used for persistent storage 106. Other examples include optical and magnetic disks, thumb drives, and smart cards that are inserted into a drive for transfer onto another computer-readable storage medium that is also part of persistent storage 106.

Communications unit 111 provides for the facilitation of electronic communications between computing systems 100. For example, between one or more computer systems or devices via a communication network. In the exemplary embodiment, communications unit 111 may include network adapters or interfaces such as a TCP/IP adapter cards, wireless interface cards, or other wired or wireless communication links. Communication networks can comprise, for example, copper wires, optical fibers, wireless transmission, routers, load balancers, firewalls, switches, gateway computers, edge servers, and/or other network hardware which may be part of, or connect to, nodes of the communication networks including devices, host systems, terminals or other network computer systems. Software and data used to practice embodiments of the present disclosure can be downloaded to the computing systems 100 operating in a network environment through communications unit 111 (e.g., via the Internet, a local area network, or other wide area networks). From communications unit 111, the software and the data of program(s) 114 can be loaded into persistent storage 116.

One or more I/O interfaces 115 may allow for input and output of data with other devices that may be connected to computing system 100. For example, I/O interface 115 can provide a connection to one or more external devices 117 such as one or more smart devices, IoT devices, recording systems such as camera systems or sensor device(s), input devices such as a keyboard, computer mouse, touch screen, virtual keyboard, touchpad, pointing device, or other human interface devices. External devices 117 can also include portable computer-readable storage media such as, for example, thumb drives, portable optical or magnetic disks, and memory cards. I/O interface 115 may connect to human-readable display 118. Human-readable display 118 provides a mechanism to display data to a user and can be, for example, computer monitors or screens. For example, by displaying data as part of a graphical user interface (GUI). Human-readable display 118 can also be an incorporated display and may function as a touch screen, such as a built-in display of a tablet computer.

The present invention may be a system, a method, and/or a computer program product at any possible technical detail level of integration. The computer program product may include a computer-readable storage medium (or media) having the computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus, or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

System for Detecting, Clearing and/or Separating Potentially Tainted Digital Assets Entering a Digital Network

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the Figures, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

The terms “transaction”, “transaction proposal”, “proposal” or “request” may be used throughout this description. It is noted that these terms may be interchangeable and may be synonymous with (unless otherwise noted) a blockchain transaction, blockchain proposal, or blockchain request, which should not be construed as a business or financial transaction. The term “transaction proposal” or “blockchain request” within a blockchain environment may refer to a proposal to commit data to the blockchain and the term “transaction” within a blockchain environment, may refer to a commitment of data to a blockchain or an execution of a smart contract code that can be performed in response to conditions associated with the smart contract being satisfied.

Embodiments of the present disclosure may utilize a decentralized database (such as a blockchain) that is a distributed storage system, which includes multiple nodes that communicate with each other. The decentralized database may include an append-only immutable data structure resembling a distributed ledger capable of maintaining records between mutually untrusted parties. The untrusted parties are referred to herein as peers, nodes, and/or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In various embodiments described herein, a permissioned and/or permissionless blockchain may be utilized. In a public or permissionless blockchain, anyone can participate without a specific identity (e.g., retaining anonymity) or presenting credentials authorizing participation. Public blockchains can involve native cryptocurrency and use a consensus based on various protocols such as Proof of Work. On the other hand, a permissioned blockchain database provides secure interactions among a group of entities which share a common goal, but which do not fully trust one another, such as businesses that exchange funds, goods, (private) information, and the like.

Referring to the drawings, FIG. 2 to FIG. 5 depict an approach that can be executed using one or more computing systems 100 operating within a computing environment 200, 400, 500 and variations thereof, to implement systems, methods, and computer program products for detecting, clearing and/or separating potentially tainted digital assets entering a digital network. Embodiments of computing environments 200, 400, 500 may include one or more computing systems 100 interconnected via the blockchain network 206. The computing systems 100 connected to the blockchain network 206 may be specialized systems or devices that may include, but are not limited to, the interconnection of one or more nodes 208a-208e, gateway nodes 202a, 202b, sending device 203, recipient device 205 and/or clearing house 220.

Embodiments of the specialized computing systems or devices exemplified in FIGS. 2-5 may not only comprise the elements of the systems and devices depicted in the drawings of FIGS. 2-5, but the specialized computing systems depicted may further incorporate one or more elements of computing system 100 shown in FIG. 1 and described above. Although not shown in the Figures, one or more elements of computing system 100 may be integrated into the embodiments of nodes 208a-208e, gateway nodes 202a, 202b, sending device 203, recipient device 205 and/or clearing house 220, including (but not limited to) the integration of one or more processor(s) 103, program(s) 114, memory 105, persistent storage 106, cache 107, communications unit 111, I/O interface(s) 115, external device(s) 117 and human-readable display 118.

FIG. 2 illustrates an embodiment of a blockchain environment 200 comprising a blockchain network 206 featuring a distributed, decentralized peer-to-peer architecture comprising a plurality of nodes 208a-208e (referred to herein generally as “peer nodes 208”. In this particular embodiment, the blockchain network 206 may be a permissionless blockchain. In a permissionless blockchain environment, anyone can join the permissionless blockchain network 206 and participate in performing functions of the blockchain. For example, to join a permissionless blockchain network 206, a user may create a personal address and begin interacting with the blockchain network 206 by submitting transaction proposals or “blockchain transactions”, adding entries to the ledger. Additionally, all parties have the choice of running a node on the system and employing the mining protocols to help verify transactions.

Whether operating within a permissioned or permissionless architecture, embodiments of the nodes of a blockchain network 206 may function as the communication entities. A “node” may perform a logical function in the sense that multiple nodes of different types can run on the same physical server. Nodes can be grouped in trust domains and can be associated with logical entities that control them in various ways. Nodes may include different types of nodes, such as a gateway node 202a, 202b intercepting transaction requests, details and digital assets for clearance by a clearing house 220 before the transactions are broadcasted to the peer nodes, client or submitting-client nodes submit a transaction-invocation to an endorser (e.g., peer), and broadcasts transaction-proposals to an ordering service (e.g., ordering node). Another type of node is a peer node 208 which can receive client submitted transactions, commit the transactions, and maintain a state and a copy of the ledger of blockchain transactions. Peer nodes 208 can also have the role of an endorser, although it is not a requirement. An ordering-service-node or “orderer” is a node running the communication service for all nodes, and which implements a delivery guarantee, such as a broadcast to each of the peer nodes in the system when committing transactions and modifying a world state of the blockchain, which may be another name for the initial blockchain transaction and may include control and setup information.

As shown in FIG. 2, an embodiment of a blockchain environment 200 may include a least one blockchain user submitting a request to perform a transaction on the blockchain network 206, using a sending device 203, and/or a recipient device 205 to contribute and/or receive one or more digital assets resulting from the completion of the verified blockchain transaction. Embodiments of the sending device 203 and/or the recipient device 205 may include a client, such as the DEX client 207a, 207b (referred to herein generally as “DEX client 207”) and a local wallet 209a, 209b (referred to generally herein as “local wallet 209”). DEX client 207 may operate as an interface that connects to and interfaces with nodes of the decentralized exchanges of the blockchain network 206. The DEX client 207 allows the user to initiate orders, access the order book, execute digital asset trades, deposits, withdraws, and accounts on the blockchain network 206. The DEX client 207 may further enable users to provide inputs and values, such the selection of digital assets to deliver and the destination addresses for wallets or accounts receiving digital assets as part of the transaction. Embodiments of DEX client 207 may be a standalone application or service running on the sending device 203 or the receiving device 205. In some instances, the DEX client 207 may be a web application accessible via a browser or an application programming interface (API).

Embodiments of the DEX client 207 may interface with the blockchain network 206 by connecting to a gateway node 202a, 202b (referred to generally herein as “gateway node 202”) of the blockchain network 206. Gateway nodes 202 may act as a control point of the blockchain network 206 for controlling incoming transactions and external digital assets flowing into the blockchain network 206. For example, digital assets being routed as part of a transaction request can be deposited from a local wallet 209 to the blockchain network 206 through the gateway node 202. In some situations where the transaction is a direct decentralized exchange of digital assets being routed between a local wallet 209a of a sending device 203 and a local wallet 209b of a recipient device 205, gateway nodes may accept the digital assets and route the digital assets to a clearing house 220 and wait for clearance of the assets before routing the assets to the destination wallet addresses, per the parameters of the transaction being ordered/executed. Likewise, in other embodiments, wherein user accounts are maintained on the blockchain network 206 for senders and/or recipients, embodiments of the gateway nodes 202 may accept incoming digital assets entering the blockchain network 206, route the assets to the clearing house 220 and upon clearance from the clearing house 220 of the assets, deposit the digital assets into the prescribed accounts provided by the blockchain network 206, as per the parameters of the transaction being ordered/executed by the blockchain network 206.

Clearing house 220 may refer to a designated intermediary between sender and recipient of a transaction that may be provided by the blockchain network 206 for the purpose of ascertaining the presence of tainted digital assets entering the blockchain network 206 from other networks or local wallets 209 residing external to the blockchain network 206. Digital assets intercepted by the gateway node 202 may be securely routed to the clearing house 220, whereby the clearing house 220 may clear the assets and/or identify tainted assets of the proposed transaction by tracking, tracing and analyzing the incoming digital assets' using the transactional histories of the digital assets. Tracking, tracing and analysis of the digital assets may be performed using programs, processes and services natively available to the blockchain network 206 and/or by utilizing programs or services provided by external service providers to the blockchain environment 200.

In the exemplary embodiment of FIG. 2, the clearing house 220 provides tracking, tracing and analysis functions using one or more of the natively available programs or services, which may include an asset tracking API 211, graph building engine 213, graph query engine 215, graph storage and indexing module 217 and asset processing module 219. The term “module” may refer to a hardware module, software module, or a module may be a combination of hardware and software resources. Embodiments of hardware-based modules may include self-contained components such as chipsets, specialized circuitry, one or more memory 105 devices and/or persistent storage 106. A software-based module may be part of a program 114, program code or linked to program code containing specifically programmed instructions loaded into a memory 105 device or persistent storage 106 device of one or more specialized computing systems 100 operating as part of the computing environment, for example computing environment 200.

Embodiments of asset tracking API 211 perform the tasks, functions and processes of the clearing house 220 by acting as an intermediary between the gateway node 202 and the applications and/or services provided by clearing house 220. The asset tracking API 211 allow the blockchain network 206, and more specifically the gateway nodes 202 to talk and interface with the software and services provided by the clearing house 220 to the blockchain network 206. Such services may include features that track, trace and analyze the potentially tainted assets provided to the blockchain network during transactions or exchanges by one or more users. Asset tracking API 211 may take the request to clear potentially tainted assets from the gateway node 202 and instruct systems, programs and services of the clearing house 220 to perform tracking, tracing and analysis operations. Moreover, upon clearance of the non-tainted assets and/or the holding of potentially tainted digital assets that may require additional scrutiny within tainted asset wallet 221, the asset tracking API 211 may return the non-tainted assets back to the blockchain network 206 via gateway node 202 and/or report to the blockchain network 206 the status of the potentially tainted assets being held within tainted asset wallet 221.

Embodiments of graph building engine 213 may perform the functions or tasks of creating directional graphs from a history of transactions executed on the blockchain network 206. The directional graph created by the graph building engine 213 is created using a series of interconnected nodes and edges that describe the transactions using one or more parameters or attributes of the transaction history. The directional graph can trace the assets of the blockchain based on historical transactions. For example, in the exemplary embodiment, the graph building engine 213 creates and dynamically maintains a directional graph wherein the nodes of the directional graph may be labelled as accounts on the blockchain network 206 or wallet addresses sending or receiving digital assets. The edges of the directional graph may be labelled with a corresponding transaction ID or other properties of the transaction occurring between the accounts or wallet addresses described by the nodes that the edges interconnect.

A “transaction” may define a transition of the state of a digital asset; for example, the state of tokens or other types of cryptocurrencies that may be sent, received and exchanged on the blockchain network 206. The state of the digital assets, such as tokens, may describe the balance, the address of the sender's account or wallet and the address of the recipient's account or wallet. Each transaction that is recorded as part of the transaction history being used to create the directional graph may only change a subset of states (i.e., the sender and/or recipient's balance of digital assets within their respective accounts) within the global state of the blockchain network 206. Accordingly, since the nodes describe the accounts or wallets of the transaction and the state of the account or wallet (i.e., asset balances) change as a result of the transactions, each node of the graph stores relevant states involved with the transaction edges of the directional graph.

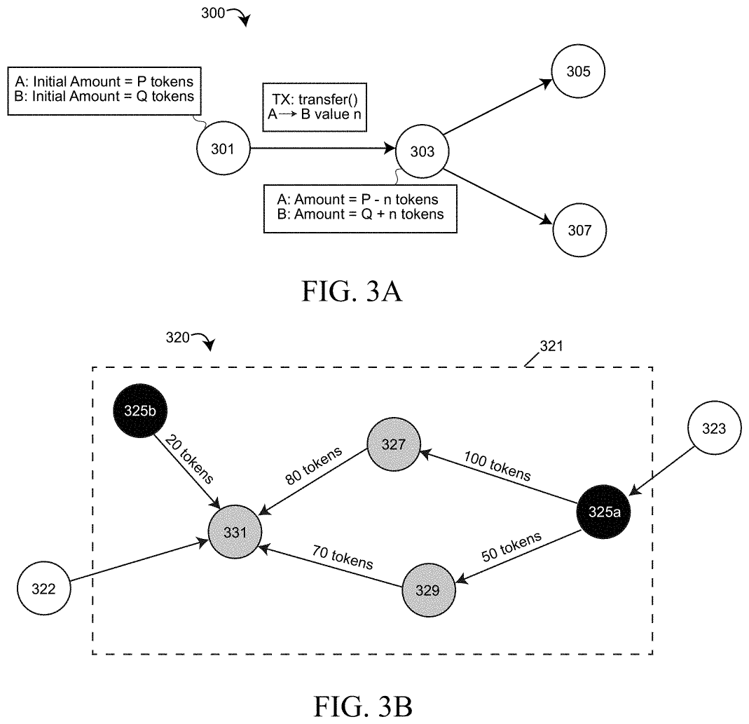

FIG. 3A provides an example of a portion of a directional graph 300 that may be mapped by the graph building engine 213. As illustrated in this example, the directional graph 300 tracks the changes in the states of account A and account B engaging in a transaction that includes an exchange of tokens between the two accounts. At node 301 of the directional graph 300, the state of account A includes an account balance of P tokens (where P could be any number or integer) and the state of account B indicates an initial balance of Q tokens (where Q could be any number or integer). At node 303, the state of accounts A and B changes as a transfer of a number (n) of tokens has been moved from account A to account B. At node 303, the state of the accounts A and B have changed as indicated, the state of account A now comprises a balance of P−n tokens, indicating a withdrawal of a number of tokens from the account in the amount of n tokens. Moreover, as indicated at node 303, the state of account B has increased by n tokens, as indicated in the illustration by balance of account B increasing from Q tokens to Q+n tokens. Furthermore, as accounts A and B engage in separate future transactions, the states of the account balances for accounts A and B may diverge from the balances recorded at node 303. For example, as balance of account A changes by participating in another transaction, the new state of account A's balance may be reflected by node 305 and any changes to the state of account B's balance as a result of a new transaction may be reflected by node 307.

Embodiments of graph storage and indexing module 217 of clearing house 220 may perform the tasks or functions of the clearing house 220 directed toward dynamically maintaining the directional graphs built by the graph building engine 213 and indexing the directional graph, allowing for quick and efficient querying of the graph when analyzing and tracking potentially tainted digital assets. The graph storage and indexing module 217 may build an index for the graph query engine 215 to search for the potentially tainted assets described by the incoming clearance request received by the asset tracking API 211. Embodiments of the index may be built by mapping one or more properties that may be used as identifying information of the potentially tainted digital assets to graphical elements of the directional graph. For example, mapping accounts or wallet addresses to the nodes and transaction IDs to the edges of the direction graph.

Embodiments of the graph query engine 215 can search the index of the directional graph stored by the graph storage and indexing module 217 for one or more of the mapped properties inputted as a query. For example, a query submitted by the graph query engine 215 to the graph storage and indexing module 217 may be searching for transaction histories associated with a particular set of accounts or wallet addresses associated with digital assets seeking to be cleared for an ongoing blockchain transaction request. In response to the query by the graph query engine 215, an output from the graph query engine 215 may include a sub-graph of the directional graph. The sub-graph may comprise the transactional scope of the potentially tainted digital assets, including accounts that may have originally tainted the assets via nefarious or unlawful means (i.e. an account that is the source of the tainted assets), accounts that may have knowingly engaged in unlawful transactions, as well as other accounts that may have unknowingly engaged in transactions that proliferated or expanded the movement of the potentially tainted digital assets throughout the accounts or wallets engaged in transactions of blockchain network 206.

FIG. 3B provides an example of a sub-graph 321 outputted from the graph query engine 215, isolating a scope of transactions associated with potentially tainted digital assets from a larger directional graph built by the graph building engine 213. As depicted in the drawing, the isolated scope of the sub-graph includes nodes 325a, 325b, 327, 329 and 331. Nodes 322 and 323 are part of the larger directional graph but remain outside of the scope of sub-graph 321. Nodes 325a, 325b indicate accounts or wallet addresses that store the state of an account identified as the source of the potentially tainted digital assets, while remaining nodes 327, 329, 331 may be either participants in past transactions that received potentially tainted assets from an account or wallet associated with node 325a, 325b or unlawful participants who knowingly received the tainted digital assets being sent to the accounts or wallets associated with nodes 327, 329 and/or 331. To produce the sub-graph as depicted in FIG. 3B, a traversal of the directional graph may be performed by the graph query engine 215. During the traversal of the directional graph, the graph query engine 215 starts from the problematic nodes and edge, indicated to be the source of the potentially tainted digital assets, to identify the movement of the tainted digital assets to accounts or wallet addresses, and the other participants related to the tainted digital assets. Using the account associated with nodes 325a, 325b of the directional graph 320 as the initial input, graph query engine 215 traverses from the two black nodes 325a, 325b producing quarantined sub-graph 321 and identifying a scope for resolving the tainted digital assets by asset processing module 219.

Embodiments of the asset processing module 219 perform the tasks or functions of the clearing house 220 directed toward processing potentially tainted digital assets within the isolated scope of the sub-graph 321 established by the graph query engine 215. The asset processing module 219 separates digital assets that may be potentially tainted from non-tainted assets and may calculate the maximum number of tainted digital assets for each account or wallet within the sub-graph 321. Holds on accounts within the sub-graph 321 may be placed by the asset processing module 219 for the maximum amount of tainted digital assets calculated. Digital assets placed on hold may be transferred to tainted asset wallet 221 while untainted assets of each account within the scope of isolation being processed by the asset processing module 219 may be transferred back to the blockchain network 206 whereby transactions that may include untainted assets may be completed.

Embodiments of the asset processing module 219 may calculate the maximum amount of tainted digital assets for withholding for each account based on the number of potentially tainted digital assets that may have been received or passed along during transactions with the identified source of the tainted assets. Using the FIG. 3B as an example, nodes 325a and node 325b comprise a wallet or account that is identified as the source of the tainted digital assets on the blockchain network 206. As shown in FIG. 3B, the account of node 325a transfers 100 tokens to an account of node 327 and 50 tokens to an account associated with node 329. Moreover, 20 tokens are transferred from tainted account or wallet of node 325b to an account associated with node 331. From the sub-graph 321, the asset processing module 219 can calculate that the maximum number of tokens to place on hold for the account of node 327 is 100 tokens and 50 tokens for the account associated with node 329, since both accounts directly received 100 tokens and 50 tokens respectively from the account or wallet identified as the source of the tainted digital assets (node 325a). With regard to the maximum number of possibly tainted digital assets received by the account associated with node 331, 20 tokens are directly received from the source of the taint, node 325b. Moreover, 80 tokens are received from the account of node 327. Since the account of node 327 received 100 potentially tainted tokes, all 80 of the tokens transferred from the account of node 327 to the account of node 331 could potentially be tainted.

Furthermore, the account of node 331 receives 70 tokens from the account of node 329. However, only 50 of the 70 tokens should be calculated as the maximal number of potentially tainted tokens because the account of node 329 only received 50 tokens from the account of node 325a. Since it would not be possible for all 70 tokens to be tainted, only 50 of the 70 tokens are calculated to be potentially tainted. Therefore, the maximum number of tokens to be placed on hold by the asset processing module 219 for the account associated with node 331 would be 150 tokens (20+80+50). Asset processing module 219 may place the appropriate maximum number of tokens for each account associated with nodes 327, 329 and 331 to the tainted asset wallet 221 and route any remaining number of tokens considered to be untainted for these accounts back to the blockchain network 206. The untainted tokens may be deposited or transferred to an account or wallet address as prescribed by a blockchain transaction that may have initiated the clearance process.

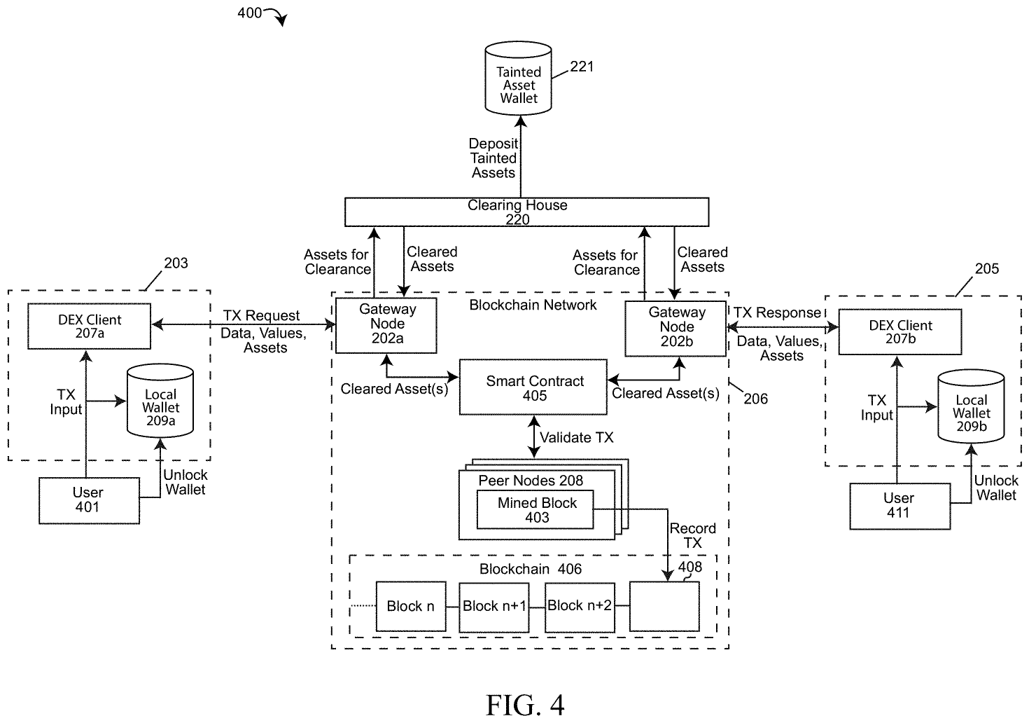

Referring now to the blockchain computing environment 400 of FIG. 4, the embodiment of FIG. 4 illustrates an example of a workflow for completing a blockchain transaction exchanging digital assets using decentralized exchange architecture. The architecture as shown in blockchain computing environment 400 clears the digital assets using a clearing house 220 to prevent potentially tainted assets entering the blockchain network 206 from proliferating or expanding their spread to other accounts of the blockchain network 206 and completing the transaction on the blockchain 406 using a smart contract 405. As shown in FIG. 4, user 401 initiates a request for a digital asset transaction by inputting the transaction details and information into DEX client 207a for transmission to the blockchain network 206. In some instances, a transaction initiated by the user 410 may be an exchange of assets, an offer to buy digital assets or an offer to sell digital assets. For digital assets maintained locally by the user 401 within a local wallet 209a of the sending device 203, that may be used to buy, sell or trade for other digital assets as part of the blockchain transaction, the user 401 may unlock the local wallet using a private key in order to transfer and/or deposit the digital assets needed to complete the transaction to the blockchain network 206. DEX client 207a communicates the initiation of the digital asset transaction to the gateway node 202a of the blockchain network 206, along with details of the transaction, data, values and assets for completing the transaction. For example, transmitting a transaction ID, the type of transaction (i.e., buy, sell, exchange), the type and amount of digital assets being contributed, the type and amount of digital assets to be received (if any), and the destination(s) for routing the digital assets to complete the transaction, including and wallet addresses and/or accounts maintained by the blockchain network 206.

User 411 operating recipient device 205 may view or receive the transaction request submitted to the blockchain network 206 via DEX client 207b and decide to participate and/or fulfill the transaction request submitted by user 401. A response to the transaction inputted by user 401 may be inputted by user 411 into DEX client 207b. In a situation where a transaction being participated in requires a contribution of digital assets by user 411, and said digital assets are maintained by user 411 on a local wallet 209b, user 411 may unlock local wallet 209 using a private key and transmit the digital assets from the local wallet 209b to the blockchain network 206 via the DEX client 207b. The transaction response along with any data, values and/or assets may be transmitted by DEX client 207b to the blockchain network 206, wherein the transaction response, data and/or values may be intercepted by gateway node 202b before proceeding to peer nodes 208 and/or smart contract 405 (if a smart contract is used, as shown in FIG. 4).

Digital assets transmitted to the blockchain network 206 and received by gateway nodes 202 may be requested for clearance using a clearing house 220 before proceeding with the blockchain transaction request submitted by the sending device 203, to ensure that none of the digital assets taking part in the transaction have been tainted by being obtained through nefarious or unlawful actions. Gateway nodes 202 may communicate with the clearing house 220 via the asset tracking API 211 and transmit a request to clear the digital assets that make up the requested transaction along with transaction details and the digital assets.

Upon receiving the clearance request, transaction details, including tainted asset descriptions (i.e., accounts or wallets, transaction ID, etc.) and/or digital assets being requested for clearance, the graph query engine 215 of clearing house 220 can query an index of a directional graph comprising transaction histories of the blockchain network 206 stored by the graph storage and indexing module 217. Based on the results of the query of the index, the graph query engine 215 may traverse the directional graph beginning with the source(s) of any potentially tainted digital assets to produce a sub-graph establishing a scope of the tainted assets that isolates the identified potentially tainted assets for further processing and a calculation of the maximum amount of possibly tainted assets. Asset processing module 219 calculates the maximum amount of potentially tainted assets that may be involved in the transaction request and contributed by each account or wallet described in the transaction details. The maximum number of potentially tainted assets calculated for each account can be transferred to the tainted asset wallet 221 and placed on hold until additional scrutiny and regulatory actions can be taken. The remaining untainted digital assets that have cleared the clearing house 220 can be returned to gateway nodes 202 and/or routed to the accounts or wallet addresses prescribed by the transaction details as the transaction request is broadcasted to all peer nodes 208 for validation and recordation to a block 408 of the blockchain 406.

In the exemplary embodiment of FIG. 4, a smart contract 405 may automatically mediate the transaction between user 401 and user 411. A smart contract may be described as data driven code that represents verifiable application logic that helps automate a system's rule set. The smart contract's code may be written to the blockchain and executed at any node in the blockchain network 206 when specific conditions of the blockchain transaction are met. For example, the terms of the smart contract 405 may include the date, location, user, machine identity, deposit of assets, etc. Fulfilling the terms defined by smart contract 405, including the deposit of the digital assets cleared by clearing house 220 with the smart contract can serve as a trigger for executing the smart contract by peer nodes 208 and performing the transaction in accordance with the rules defined by the code. The peer nodes 208 validate the transaction, storing the transaction in the mined block 403 comprising a hash value created for that mined block 403 and recording the mined block to a block 408 of the blockchain 406. Moreover, executing the smart contract can result in changes in state to the account or wallet addresses of the users 401, 411 involved in the transaction. Namely, changes to the balance of the accounts or wallets. For example, upon delivery of the cleared assets provided by user 401 to the local wallet 209b of user 411, smart contract 405 transfers digital assets provided by user 411 to the local wallet 209a controlled by user 401.

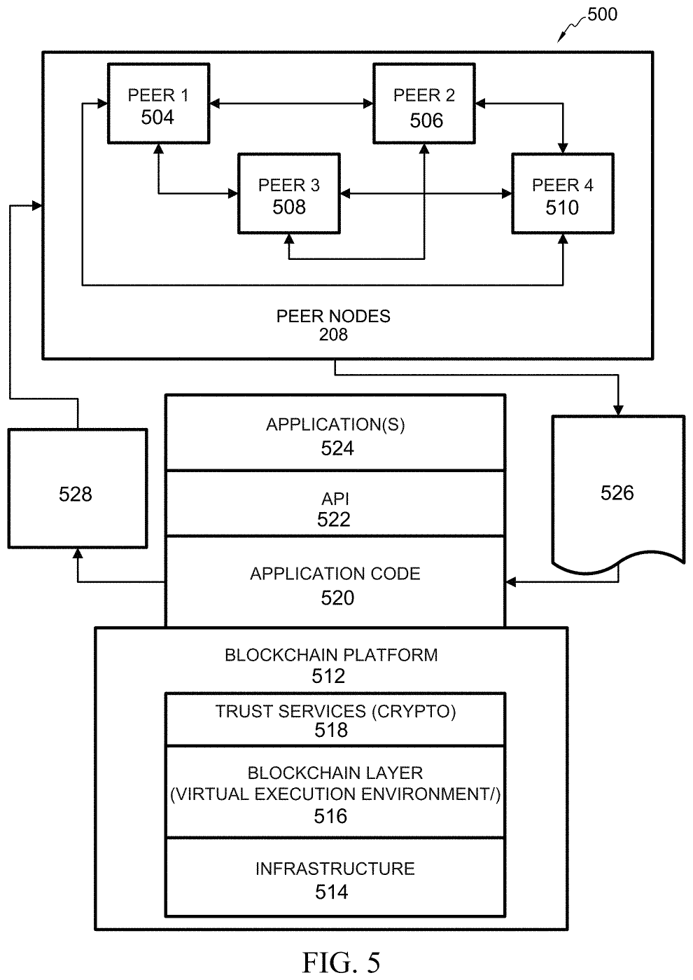

FIG. 5 illustrates an example embodiment of blockchain architecture 500 of a blockchain network 206 and one or more components thereof. As shown in FIG. 5, the architecture 500 of a blockchain network 206 may include certain elements. For example, a group of peer nodes 208. While four peers 504, 506, 508, 510 are depicted in FIG. 5, the number of peers 504, 506, 508, 510 are not limited to only four, and any number of peers may be participating in the blockchain network 206. The plurality of peers 504, 506, 508, 510 may participate in several activities, such as blockchain transaction addition and validation process (consensus). One or more of the peers 504, 506, 508, 510 may endorse transactions based on endorsement policy and may provide an ordering service for blockchain nodes within the architecture 500. Embodiments of a peer nodes 208 may initiate a blockchain request for authentication and seek to write to a blockchain immutable ledger stored in blockchain layer 516, a copy of which may also be stored on the underpinning physical infrastructure 514. The blockchain configuration may include one or more applications 524 which are linked to application programming interfaces (APIs) 522 to access and execute stored program/application code 520 (e.g., chain code, smart contracts, etc.). The applications 524 and application code 520 can be created according to a customized configuration sought by participants and can maintain their own state, control their own assets, and receive external information. These applications 524 executed by a node 208, can be deployed as a transaction and installed, via appending to the distributed ledger, on all peers 504, 506, 508, 510 of the peer nodes 208.

Embodiments of the blockchain platform 512 may include various layers of blockchain data, services (e.g., cryptographic trust services 518, virtual execution environment of a blockchain layer 516, etc.), and underpinning physical computer infrastructure 514 that may be used to receive and store new blockchain transactions for transactions and provide access to auditors which are seeking to access data entries. The blockchain layer 516 may expose an interface that provides access to the virtual execution environment necessary to process the application code 520 and engage the physical infrastructure 514. Cryptographic trust services 518 may be used to verify transactions such as asset exchange transactions and keep information private.

Blockchain program or application code 520 may be executed via one or more interfaces exposed and/or services provided by the blockchain platform 512. The blockchain's application code 520 may control one or more digital assets of the blockchain network 206. For example, the application code 520 may store and transfer data, and may be executed by peer nodes 208 in the form of a smart contract and associated chain code with conditions or other code elements subject to its execution. The smart contracts can themselves be used to identify rules associated with authorization and access requirements and usage of the ledger. For example, the transactions 526 may be processed by one or more processing entities (e.g., virtual machines) included in the blockchain layer 516. The result 528 may include a transfer or exchange of cleared digital assets to the wallet addresses or accounts prescribed by the transaction details. In some embodiments, the physical infrastructure 514 may be utilized to retrieve any of the data/information/assets/etc. described herein.

In some cases, specialized chain codes may exist for management functions and parameters which are referred to as system chain code (such as managing an ordering/serialization of transactions to be committed to a blockchain network 206). In some embodiments, the method, system, and/or computer program product can further utilize smart contracts that are trusted distributed applications which leverage tamper-proof properties of the blockchain database and an underlying agreement between peer nodes 208, which may be referred to as an endorsement or endorsement policy. An endorsement policy may allow chain code to specify endorsers for a transaction in the form of a set of peers 504, 506, 508, 510, that may be necessary for endorsement. When a transaction is broadcasted to the peers (e.g., endorsers) specified in the endorsement policy, the transaction is executed to validate the transaction. After validation, the transactions may enter an ordering phase in which a consensus protocol is used to produce an ordered sequence of endorsed transactions grouped into blocks.

A smart contract may be created via a high-level application and programming language, and then written to a block in the blockchain. The smart contract may include executable code which is registered, stored, and/or replicated with a blockchain (e.g., distributed network of blockchain peers). A transaction may be an execution of the smart contract code which can be performed in response to conditions associated with the smart contract being satisfied. The execution of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols. Embodiments of a smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chain code may include the code interpretation of a smart contract, with additional features. As described herein, the chain code may be program code deployed on a computing network, where it is executed and validated by chain validators together during a consensus process. The chain code receives a hash and retrieves from the blockchain a hash associated with the data template created by use of a previously stored feature extractor. If the hashes of the hash identifier and the hash created from the stored identifier template data match, then the chain code sends an authorization key to the requested service. The chain code may write to the blockchain data associated with the cryptographic details.

Method for Detecting, Clearing and/or Separating Tainted or Potentially Tainted Digital Assets

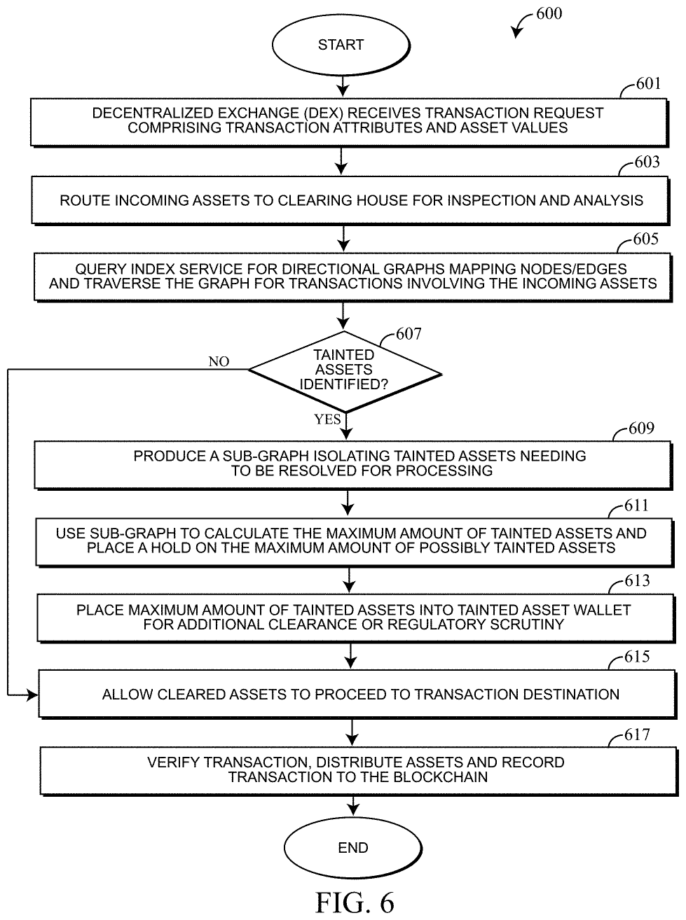

The drawings of FIG. 6 represents an embodiment of a method for detecting, clearing and/or separating tainted or potentially tainted digital assets from untainted digital assets in accordance with FIGS. 2-5 above, using one or more computing systems defined generically by computing system 100 of FIG. 1 and more specifically by the embodiments of specialized computer systems depicted in FIGS. 2-5 and as described herein. A person skilled in the art should recognize that the steps of the method 600 described by FIG. 6 may be performed in a different order than presented and may not require all the steps described herein to be performed.

The embodiment of the method 600 may begin at step 601. During step 601 a gateway node 202 of a blockchain network 206 operating as a DEX may receive a transaction request from sending device 203 via a DEX client 207a being executed by the sending device 203. Embodiments of the transaction request may include transaction details including a transaction ID, the sender's account or wallet address, a recipient account or wallet address, and the subject of the transaction including the amount and type of digital assets being transferred, purchased, exchanged, etc. One or more digital assets required to fulfill the proposed blockchain transaction may be transmitted to the gateway node alongside the transaction request and the transaction details. In step 603, the gateway node 202 receiving the transaction request, transaction details and digital assets may route the incoming assets, transaction request and transaction details to a clearing house 220 configured to track, trace and analyze the transaction histories of the digital assets involved with the transaction as well as the wallets or accounts sending and/or receiving the digital assets in order to identify and withhold any potentially tainted digital assets that may be transferred or delivered as part of the incoming transaction request of step 601.

In step 605 of method 600, a clearance request for the assets routed to the clearing house 220 in step 603 may be transmitted to the asset tracking API 211. The clearing house 220 receiving the clearance request may begin fulfilling the request by querying, using the graph query engine 215, an index of a directional graph stored and maintained by the graph storage and indexing module 217. The index being queried comprises a mapping of nodes and edge of the directional graph comprising a transaction history of the blockchain network in graphical form. For example, nodes may be mapped to accounts or wallets involved in historical transactions on the blockchain network 206, while the edges connecting the nodes comprise transaction details, such as the transaction IDs for the historical transactions. Embodiments of the graph query engine 215 may traverse the directional graph beginning with any nodes identified as being a source of accounts or wallets known to contain tainted assets and any wallets or accounts that may be a party to the current transaction request.

In step 607, a determination is made whether any tainted assets are identified and whether any of the potentially tainted digital assets have possibly been transferred to one or more of the parties involved in the current transaction being cleared by the clearing house 220. If none of the accounts or wallets have been connected to a source of tainted assets, the method 600 may proceed to step 615, clearing the digital assets of the transaction, and allowing the transaction to proceed with routing the digital assets to the prescribed destination(s) as described by the transaction details of the transactions request. Conversely, when potentially tainted assets are identified in step 607 as being connected within the directional graph to one or more wallets or accounts that are a party to the transaction request, the method 600 may proceed to step 609. During step 609, the graph query engine 215 produces a sub-graph during the traversal of the directional graph, beginning with any sources of the potentially tainted digital assets as the initial input and identifying the movement of the digital assets between accounts or wallet addresses of victims and/or participants of the historical transactions. The graph query engine isolates the scope of the potentially tainted digital assets that may need to be resolved by the asset processing module 219, to produce a sub-graph.

Using the sub-graph generated by the graph query engine 215, the asset processing module 219 may in step 611 of method 600, calculate a maximum amount of potentially tainted assets that may have been transferred to one or more accounts within the sub-graph, including the accounts or wallets that may be subject to the transaction request. The maximum amount of potentially tainted assets may be placed on hold, and in step 613, the maximum amount of potentially tainted assets may be transferred into tainted asset wallet 221 for additional clearance processing and regulatory scrutiny. Any untainted assets that may be outside of the maximum amount calculated by the asset processing module 219 may be cleared for proceeding in accordance with the transaction request.

In step 615, the clearing house 220, via the asset tracking API 211, may transmit the cleared, untainted assets back to the blockchain network 206. For example, by transferring the untainted digital assets back to the gateway node of the blockchain network 206, and/or route the cleared, untainted digital assets to the one or more accounts and/or wallet addresses prescribed by the transaction details of the transaction request. In step 617, the transaction may proceed in accordance with the transaction request based on the deposit or transferal of the cleared digital assets. The blockchain transaction may be broadcasted to peer nodes, verified, and recorded to a block of the blockchain. The digital assets of the blockchain transaction may be distributed to the recipients as described by the blockchain transaction details and/or in accordance with any smart contracts that may being fulfilled and executed by the blockchain network 206.

What is claimed is:

1. A computer-implemented method, the method comprising:
routing, by a processor, potentially tainted digital assets entering a blockchain network as part of a blockchain transaction to a clearing house;
querying, by the processor, an index maintained by the clearing house, said index mapping identifying information of the potentially tainted digital assets to elements of a directional graph;
traversing, by the processor, the directional graph to isolate a sub-graph depicting movement of the potentially tainted digital assets between accounts or wallet addresses;
separating, by the processor, the potentially tainted digital assets involved in the blockchain transaction from non-tainted assets isolated within the sub-graph;
calculating, by the processor, a maximum amount of the potentially tainted digital assets moved between the accounts or the wallet addresses of the sub-graph; and
holding, by the processor, the maximum amount of the potentially tainted digital assets within a tainted asset wallet accessible to the clearing house and isolated from the blockchain network.

2. The computer-implemented method of claim 1, further comprising:
transferring, by the processor, the maximum amount of the potentially tainted digital assets to the tainted asset wallet for additional clearance or regulatory scrutiny; and
transferring, by the processor, the non-tainted assets to a destination account or destination wallet address prescribed by parameters of the blockchain transaction.

3. The computer-implemented method of claim 1, wherein the blockchain network is a decentralized exchange.

4. The computer-implemented method of claim 1, wherein the identifying information of the potentially tainted digital assets mapped to the directional graph include the accounts or the wallet addresses receiving a number of the potentially tainted digital assets mapped to each node and a transaction ID for corresponding transfers of the potentially tainted digital assets mapped to edges between each node.

5. The computer-implemented method of claim 4, wherein the traversing of the directional graph begins at a problematic account or problematic wallet address identified as a source of the potentially tainted digital assets.

6. The computer-implemented method of claim 1, further comprising:
receiving, by the processor, the non-tainted assets cleared by the clearing house;
depositing, by the processor, the non-tainted assets cleared by the clearing house with a smart contract written as a program on the blockchain network to execute the blockchain transaction, wherein depositing the non-tainted assets fulfills terms of the smart contract; and
upon fulfilling the terms of the smart contract, executing, by the processor the smart contract.

7. The computer-implemented method of claim 6, further comprising:
upon executing the smart contract, verifying, by the processor, the blockchain transaction by peer nodes of the blockchain network;
transferring, by the processor, the non-tainted assets deposited with the smart contract to a destination wallet or destination account prescribed by the terms of the smart contract; and
recording, by the processor, completion of the blockchain transaction to a block added to a blockchain of the blockchain network.

8. A computer program product comprising:
one or more computer readable storage media having computer-readable program instructions stored on the one or more computer readable storage media, said program instructions executes a computer-implemented method comprising:
routing, by a processor, potentially tainted digital assets entering a blockchain network as part of a blockchain transaction, to a clearing house;
querying, by the processor, an index maintained by the clearing house, said index mapping identifying information of the potentially tainted digital assets to elements of a directional graph;
traversing, by the processor, the directional graph to isolate a sub-graph depicting movement of the potentially tainted digital assets between accounts or wallet addresses;
separating, by the processor, the potentially tainted digital assets involved in the transaction from non-tainted assets isolated within the sub-graph;
calculating, by the processor, a maximum amount of the potentially tainted digital assets moved between the accounts or the wallet addresses; and
holding, by the processor, the maximum amount of the potentially tainted digital assets within a tainted asset wallet accessible to the clearing house and isolated from the blockchain network.

9. The computer program product of claim 8, further comprising:
transferring, by the processor, the maximum amount of the potentially tainted digital assets to the tainted asset wallet for additional clearance or regulatory scrutiny; and
transferring, by the processor, the non-tainted assets to a destination account or wallet address prescribed by parameters of the blockchain transaction.

10. The computer program product of claim 8, wherein the blockchain network is a decentralized exchange.

11. The computer program product of claim of claim 8, wherein the identifying information of the potentially tainted digital assets mapped to the directional graph include the accounts or the wallet addresses receiving a number of the potentially tainted digital assets mapped to each node and a transaction ID for corresponding transfers of the potentially tainted digital assets mapped to edges between each node.

12. The computer program product of claim of claim 11, wherein the traversing of the directional graph begins at a problematic account or problematic wallet address identified as a source of the potentially tainted digital assets.

13. The computer program product of claim of claim 8, further comprising:
receiving, by the processor, the non-tainted assets cleared by the clearing house;
depositing, by the processor, the non-tainted assets cleared by the clearing house with a smart contract written as a program on the blockchain network to execute the blockchain transaction, wherein depositing the non-tainted assets fulfills terms of the smart contract; and
upon fulfilling the terms of the smart contract, executing, by the processor the smart contract.

14. The computer program product of claim 13, further comprising:
upon executing the smart contract, verifying, by the processor, the blockchain transaction by peer nodes of the blockchain network;
transferring, by the processor, the non-tainted assets deposited with the smart contract to a destination wallet or destination account prescribed by the terms of the smart contract; and
recording, by the processor, completion of the blockchain transaction to a block added to a blockchain of the blockchain network.

15. A computer system comprising:
a processor;
one or more manufacturing systems in communication with the processor; and
a computer-readable storage media coupled to the processor, wherein the computer-readable storage media contains program instructions executing a computer-implemented method comprising the steps of:
routing, by the processor, potentially tainted digital assets entering a blockchain network as part of a blockchain transaction, to a clearing house;
querying, by the processor, an index maintained by the clearing house, said index mapping identifying information of the potentially tainted digital assets to elements of a directional graph;
traversing, by the processor, the directional graph to isolate a sub-graph depicting movement of the potentially tainted digital assets between accounts or wallet addresses;
separating, by the processor, the potentially tainted digital assets involved in the transaction from non-tainted assets isolated within the sub-graph;
calculating, by the processor, a maximum amount of the potentially tainted digital assets moved between the accounts or the wallet addresses; and
holding, by the processor, the maximum amount of the potentially tainted digital assets within a tainted asset wallet accessible to the clearing house and isolated from the blockchain network.

16. The computer system of claim 15, further comprising:
transferring, by the processor, the maximum amount of the potentially tainted digital assets to the tainted asset wallet for additional clearance or regulatory scrutiny; and
transferring, by the processor, the non-tainted assets to a destination account or wallet address prescribed by parameters of the blockchain transaction.

17. The computer system of claim 15, wherein the identifying information of the potentially tainted digital assets mapped to the directional graph include the accounts or the wallet addresses receiving a number of the potentially tainted digital assets mapped to each node and a transaction ID for corresponding transfers of the potentially tainted digital assets mapped to edges between each node.

18. The computer system of claim 17, wherein the traversing of the directional graph begins at a problematic account or problematic wallet address identified as a source of the potentially tainted digital assets.

19. The computer system of claim 15, further comprising:
receiving, by the processor, the non-tainted assets cleared by the clearing house;
depositing, by the processor, the non-tainted assets cleared by the clearing house with a smart contract written as a program on the blockchain network to execute the blockchain transaction, wherein depositing the non-tainted assets fulfills terms of the smart contract; and
upon fulfilling the terms of the smart contract, executing, by the processor the smart contract.

20. The computer system of claim 19, further comprising:
upon executing the smart contract, verifying, by the processor, the blockchain transaction by peer nodes of the blockchain network;
transferring, by the processor, the non-tainted assets deposited with the smart contract to a destination wallet or destination account prescribed by the terms of the smart contract; and
recording, by the processor, completion of the blockchain transaction to a block added to a blockchain of the blockchain network.
